(19) United States
(12) Patent Application Publication
(10) Pub. No.: US 2013/0103300 A1
(43) Pub. Date: Apr. 25, 2013

(54) METHOD AND APPARATUS FOR PREDICTING A TRAVEL TIME AND DESTINATION BEFORE TRAVELING

(71) Applicants: Thanawin Rakthanmanon, Riverside, CA (US); Dong Li, Columbus, OH (US); Dominic Letz, Berlin (DE)

(72) Inventors: Thanawin Rakthanmanon, Riverside, CA (US); Dong Li, Columbus, OH (US); Dominic Letz, Berlin (DE)

(73) Assignee: Nokia Corporation, Espoo (FI)

(21) Appl. No.: 13/280,867

(22) Filed: Oct. 25, 2011

(51) Int. Cl. G01C 21/00

(52) U.S. Cl. 701/408; 701/400

(57) ABSTRACT

An approach is provided for providing driving assistant services to a user before, during, and after the user starts traveling. Specifically, a personal travel pattern associated with a device, the user of a device, or a combination thereof is processed to determine at least one prediction of a time that the device, the user, or a combination thereof will travel to at least one or more travel paths, one or more places of interest, or a combination thereof. The travel information associated with the at least one of the one or more travel paths, the one or more places of interest, or a combination thereof is presented to the user prior to the time predicted. The travel information is also processed to cause, at least in part, a generation of a recommendation of at least one alternate travel path, at least one alternate place of interest, or a combination thereof.

### BACKGROUND

Service providers and device manufacturers (e.g., wireless, cellular, etc.) are continually challenged to deliver value and convenience to consumers by, for example, providing compelling network services. One area of development has been the use of location based services to provide users with driving assistant services to improve the quality of their travels, particularly while commuting. For example, a number of these services can predict traffic along a given travel path when a user is driving or they can determine a user's traveling paths from his or her calendar events. However, these services are unable to make predictions prior to the user starting his or her travels and they often require the user to input the traveling event into a digital calendar ahead of time. Consequently, there are numerous circumstances when these services are unable to provide users with effective driving assistant services.

### Some Example Embodiments

Therefore, there is a need for an approach for providing driving assistant services to a user before the user starts traveling.

According to one embodiment, a method comprises processing and/or facilitating a processing of a personal travel pattern associated with a device, a user of the device, or a combination thereof to determine one or more travel paths, one or more places of interest, or a combination thereof. The method also comprises processing and/or facilitating a processing of the personal travel pattern to determine at least one prediction of a time that the device, the user, or a combination thereof will travel to at least one of the one or more travel paths, the one or more places of interest, or a combination thereof based at least in part, on a learned understanding of the user's habits. The method further comprises causing, at least in part, a presentation of travel information associated with the at least one of the one or more travel paths, the one or more places of interest, or a combination thereof prior to the time.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of a personal travel pattern associated with a device, a user of the device, or a combination thereof to determine one or more travel paths, one or more places of interest, or a combination thereof. The apparatus is also caused to process and/or facilitate a processing of the personal travel pattern to determine at least one prediction of a time that the device, the user, or a combination thereof will travel to at least one of the one or more travel paths, the one or more places of interest, or a combination thereof based, at least in part, on a learned understanding of the user's habits. The apparatus is further caused to cause, at least in part, a presentation of travel information associated with the at least one of the one or more travel paths, the one or more places of interest, or a combination thereof prior to the time.

According to another embodiment, a computer-readable storage medium carries one or more sequences of one or more instructions which, when executed by one or more processors, cause, at least in part, an apparatus to process and/or facilitate a processing of a personal travel pattern associated with a device, a user of the device, or a combination thereof to determine one or more travel paths, one or more places of interest, or a combination thereof. The apparatus is also caused to process and/or facilitate a processing of the personal travel pattern to determine at least one prediction of a time that the device, the user, or a combination thereof will travel to at least one of the one or more travel paths, the one or more places of interest, or a combination thereof based, at least in part, on a learned understanding of the user's habits. The apparatus is further caused to cause, at least in part, a presentation of travel information associated with the at least one of the one or more travel paths, the one or more places of interest, or a combination thereof prior to the time.

According to another embodiment, an apparatus comprises means for processing and/or facilitating a processing of a personal travel pattern associated with a device, a user of the device, or a combination thereof to determine one or more travel paths, one or more places of interest, or a combination thereof. The apparatus also comprises means for processing and/or facilitating a processing of the personal travel pattern to determine at least one prediction of a time that the device, the user, or a combination thereof will travel to at least one of the one or more travel paths, the one or more places of interest, or a combination thereof based, at least in part, on a learned understanding of the user's habits. The apparatus further comprises means for causing, at least in part, a presentation of travel information associated with the at least one of the one or more travel paths, the one or more places of interest, or a combination thereof prior to the time.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing driving assistant services to a user before, during, and after the user starts traveling, according to one embodiment;

FIG. 2 is a diagram of the components of a travel platform, according to one embodiment;

FIGS. 3A and 3B are flowcharts of processes for providing driving assistant services to a user before, during, and after the user starts traveling, according to one embodiment;

FIGS. 4A and 4B are diagrams of user interfaces utilized in the processes of FIGS. 3A and 3B, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for providing driving assistant services to a user before, during, and after the user starts traveling are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

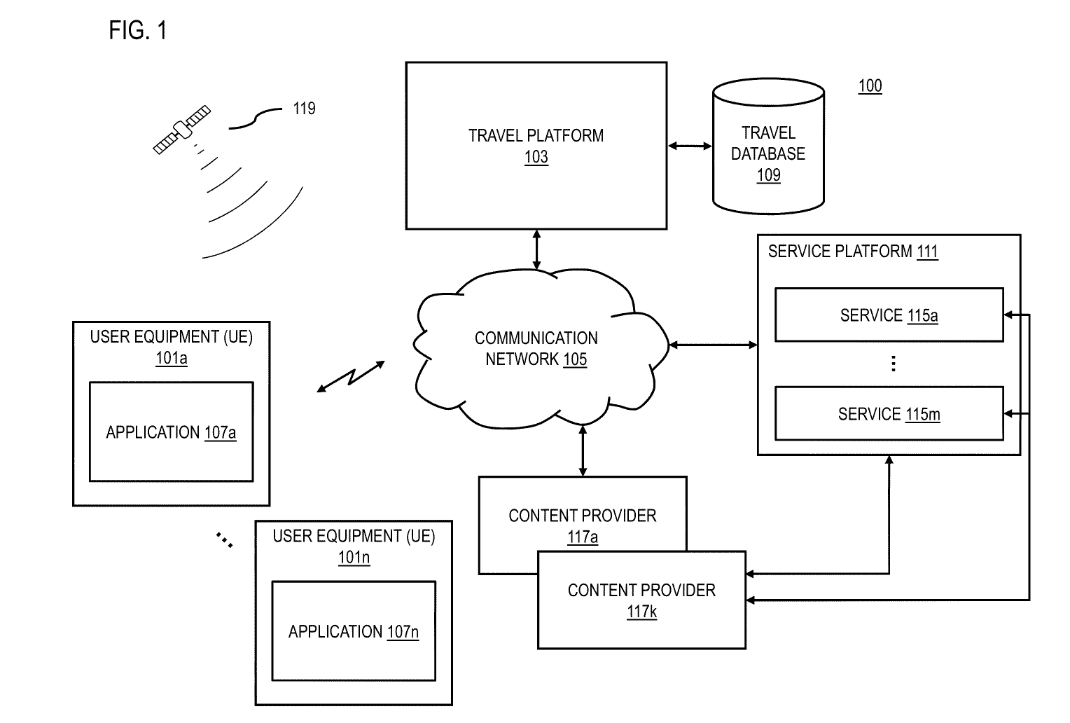

FIG. 1 is a diagram of a system capable of providing driving assistant services to a user before, during, and after the user starts traveling, according to one embodiment. It is increasingly popular for service providers and device manufacturers to bundle or make available navigation and mapping services (e.g., turn-by-turn navigation) on an array of user devices (e.g., mobile handsets, computers, navigation devices, etc.). Such devices may utilize location-based technologies (e.g., Global Positioning System (GPS) receivers, cellular triangulation, assisted-GPS (A-GPS), etc.) to provide navigation and mapping information. This type of information is particularly helpful in situations where a user in unfamiliar with his or her settings. However, where the user is familiar with the settings, especially during his or her commute (e.g., to and from work), this type of information is often inefficient. In particular, research suggests that the user's own trace data of what happened yesterday along his or her travel path (e.g., elapsed driving time) is more indicative of future driving times along the same path as opposed to predications made by generic navigation and mapping services based on a large sampling of a population. In addition to being less accurate, generic travel predications often require the user to input the traveling event into a digital calendar ahead of time. Moreover, in instances where a driving prediction (e.g., traffic on a particular traveling route) is only made when the user is already driving, it is impossible to provide the user with driving assistant services before the user starts traveling (e.g., alerting the user to leave ten minutes earlier to avoid an unforeseen traffic disruption).

To address this problem, a system 100 of FIG. 1 introduces the capability of providing driving assistant services to a user before, during, and after the user starts traveling. More specifically, the system 100 determines a user's travelling patterns by taking advantage of the various location-based technologies commonly associated with today's mobile devices (e.g., a mobile phone) such as cellular triangulation and/or GPS. For instance, the user's mobile device can record exactly where and at what time the user is driving on a particular day to learn the user's travel paths and places of interest (POIs) (e.g., work, home, lunch restaurant, kindergarten, church, supermarket, school, etc.). These travel paths and places of interest are essential components for determining the user's traveling patterns. The system 100 can then construct a traveling graph and/or prediction model based on the user's travel paths, places of interest, or a combination thereof. The travel graph can be any model which considers the user's historical GPS data and/or driving data (e.g., temporal data, traveling speed data, etc.) to determine the relationships between the starting places and the ending places along the user's travel paths. For example, the travel graph can be a probabilistic model (e.g., a Bayesian or Markov network). Specifically, the travel graph enables the system 100 to make a prediction of the time that the device, the user, or a combination thereof will travel to at least one of the one or more travel paths, the one or more places of interest, or a combination thereof based, at least in part, on a learned understanding of the user's habits. As an example, the system 100 can predict that at 8:00 a.m. the user will drive from his or her home to work along Route One. Because of the system 100's compilation of travel paths and places of interest, the system 100 is able to make this prediction before the user starts traveling (e.g., at 7:30 a.m.). In addition, the system 100 is able to make predictions from places the user has never visited before. For example, if the user is going to a new supermarket after work, the system 100 can predict that the user is going home after the supermarket because the system 100 is able to determine that the time of day after shopping is routinely associated with the user going home. It is contemplated that the system 100's prediction resembles the user's experience. In this sense, the prediction made by the system 100 is an enhancement to the route calculations already made by the user. Moreover, as a result of the prediction, the system 100 can monitor various forms of information services (e.g., traffic and weather channels) to determine if there are any unexpected disruptions along the user's travel path (e.g., traffic accidents, inclement weather, etc.) in order to alert the user to leave early for work and/or take an alternative travel path.

In addition, to making predictions before a user begins traveling, the system 100 can also provide driving assistant services to the user during the user's travels. For example, the system 100 can monitor location information associated with a mobile device while the user is traveling to one or more travel paths, the one or more places of interest, or a combination thereof to determine one or more travel decision points (e.g., a fork in the road or an accident) based, at least in part, on the location information associated with the device, the user, or a combination thereof. As a result of this determination, the system 100 can then cause, at least in part, the generation, a presentation, or a combination thereof of a recommendation of an alternative travel path or place of interest in order for the user to avoid being delayed along his or her travel path. In addition to recommending an alternative route to the user's place of interest (e.g., a supermarket), the system 100 can also recommend an alternative place of interest (e.g., a nearby supermarket). In certain situations, even in the absence of a traffic disruption or delay along a traveling path, the system 100 can also cause a recommendation of an alternative nearby point of interest (e.g., a new supermarket or coffee shop) based on an advertisement provided by the new supermarket or coffee shop.

Even after a user arrives at a particular place of interest, the system 100 can still provide the user with driving assistant services. For example, the system 100 can determine and then present to the user the amount of travel time that he or she saved by accepting the system 100's recommendation to leave early for work or to travel along an alternative travel path. In addition, the system 100 can determine and then present to the user additional feedback information such as an eco-friendliness score, a safety score, or a combination thereof based on the travel paths taken between places of interest. It is also contemplated that at the completion of each travel path, the system 100 incorporates the newly acquired travel information to update and improve the accuracy of future predictions and recommendations generated by the system 100.

As shown in FIG. 1, the system 100 comprises one or more user equipment (UE) 101a-101n (also collectively referred to as UEs 101) having connectivity to a travel platform 103 via a communication network 105. The personal travel pattern (e.g., travel paths and places of interest) is utilized by applications 107a-107n (also collectively referred to as applications 107) at the UEs 101 to provide a user with driving assistant services. Moreover, the personal travel pattern, such as one or more travel paths, one or more places of interest, or a combination thereof may be included in a travel database 109 associated with the travel platform 103 for access by the applications 107. For example, if a user decides to use more than one UE 101 or decides to purchase a new UE 101, all of the learned personal travel patterns can be automatically retrieved from the travel database 109 independently of the one or more UEs 101.

In one embodiment, the travel platform 103 processes and/or facilitates a processing of the personal travel pattern to determine at least one prediction of a time that a UE 101, the user, or a combination thereof will travel to at least one or more travel paths, the one or more places of interest, or a combination thereof. The travel platform 103 is able to make this prediction based on a determination by the travel platform 103 to construct a travel graph and/or prediction model comprising a user's one or more travel paths, one or more places of interest, one or more travel associated travel times, associated contextual information, or a combination thereof. As previously discussed, the user's travel graph is based, at least in part, on the travel platform 103 processing and/or facilitating a processing of the user's personal travel pattern (e.g., travel paths and places of interest) to determine one or more relationships among the one or more travel paths, the one or more places of interest, or a combination thereof. Based on the travel graph, the travel platform 103 is able to cause, at least in part, a presentation of travel information (e.g., average travel time) associated with the at least one of the user's one or more travel paths, one or more places of interest, or a combination thereof prior to the predicted time. For example, if the travel platform 103 determines it is Monday morning at 7:00 a.m., the travel platform 103 can predict that the user will start his or her commute to work from his or her home at 8:00 a.m. and therefore cause, at least in part, a presentation to the user of travel information at 7:30 a.m. for example.

In certain embodiments, the travel platform 103 may determine to associate, superimpose, and/or supplant the personal travel pattern with real-time travel information (e.g., traffic, weather, construction, advertising, etc.) as part of a recommendation of at least one alternate travel path, at least one alternate place of interest, or a combination thereof. The travel information may be provided by the service platform 111, which includes one or more services 115a-115m (e.g., news services, weather services, etc.), one or more content providers 117a-117k (e.g., local news stations, local municipalities, etc.), and other content sources available or accessible over the communication network 105. The travel platform 103 causes, at least in part, the generation of a recommendation of at least one alternate travel path, at least one alternative place of interest, or a combination thereof, when the travel platform 103 determines that a UE 101 is within proximity to one or more travel decision points (e.g., a fork in the road, a traffic accident, etc.). As previous discussed, the UE 101 may utilize location-based technologies (GPS receivers, cellular triangulation, A-GPS, etc.) to determine location and temporal information regarding the UE 101. For instance, the UE 101 may include a GPS receiver to obtain geographic coordinates from satellites 119 to determine the current location and time associated with the UE 101. In addition, the travel platform 103 may cause, at least in part, an update of the at least one prediction, the travel information, the recommendation, or a combination there of periodically, according to a schedule, on demand, a re-evaluation of a user's alternatives during the user's travel based, at least in part, on the most up-to-date real-time information available or a combination thereof for a predetermined period prior to, during, or after a commencement of travel.

In one sample case, the travel platform 103 determines that the day is Monday and the time is 7:00 a.m. The travel platform 103 predicts based on a user's travel graph contained within the travel database 109 that at 8:00 a.m. there is a high probability that the user will drive from his or her home to work along the travel paths Route One or Route Two. As a result, the travel platform 103 causes, at least in part, a presentation to the user at 7:30 a.m. through a UE 101 of the typical traveling time for each route (e.g., 40 minutes on Route One and 60 minutes on Route Two). This information is presented to the user in order to assist the user to make a decision as to which route to take this Monday morning. For example, if the user has a meeting at 9:00 a.m., the user may want to take Route One to ensure arriving at work in time for the meeting. On the other hand, if the user does not have to be at work until 9:30 a.m., the user may want to spend an extra twenty minutes commuting to work because Route Two is a more scenic travel path. The travel platform 103 may also process and/or facilitate a processing of travel information (e.g., weather or scheduled road maintenance) to determine whether to recommend to the user an alternative route (e.g., Route Three) or to recommend that the user take Route Two in this particular instance because the travel platform 103 is able to determine from a local municipality service 115 that road maintenance is scheduled for this Monday morning on Route One, which is likely to delay the user's arrival time at work. In this example, even though it will close, the travel platform 103 recommends that the user take Route Two to arrive at work by 9:00 a.m.

In one example, the user follows the recommendation of the travel platform 103 and travels along the Route Two travel path. Once the travel platform 103 determines that the UE 101 has commenced Monday morning's commute, the travel platform 103 can cause, at least in part, a monitoring of location information associated with the UE 101 to determine one or more travel decision points (e.g., a fork in the road between Routes One and Two) based, at least in part, on the location information associated with the UE 101. In this example, at the travel decision point, the travel platform 103 determines through the service platform 111 and a local news service 115 that the scheduled road maintenance on Route One has, in fact, been postponed. Therefore, the travel platform 103 causes, at least in part, the generation, a presentation, or a combination thereof of a new recommendation to the user regarding the advantages and disadvantages of the two routes. Having been informed by the travel platform 103 that Route One is clear, the user determines to continue on Route One in order to arrive at work before the 9:00 a.m. Once the user arrives at work (i.e., at the end destination of the Monday morning commute), the travel platform 103 can present to the user through the UE 101 the amount of time that the user saved as a result of the travel platform 103's recommendations. In one example, if the travel platform 103 determined through cellular triangulation or GPS that the user was not at a particular travel decision point at the predicted time and location, the travel platform 103 could determine that the user is, in fact, not commuting to work (e.g., traveling on a day off). In this instance, the one or more travel paths, the one or more places of interest would not be combined with the travel graph information representing the user's typical Monday commute to work in order to ensure prediction accuracy in the future.

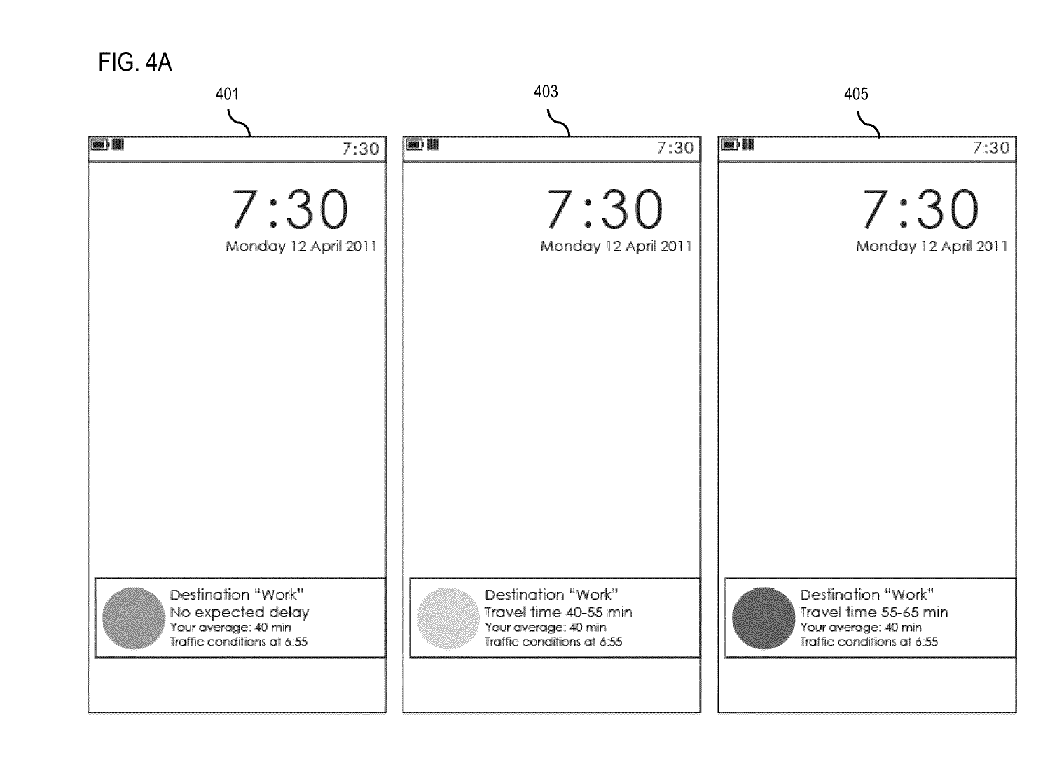

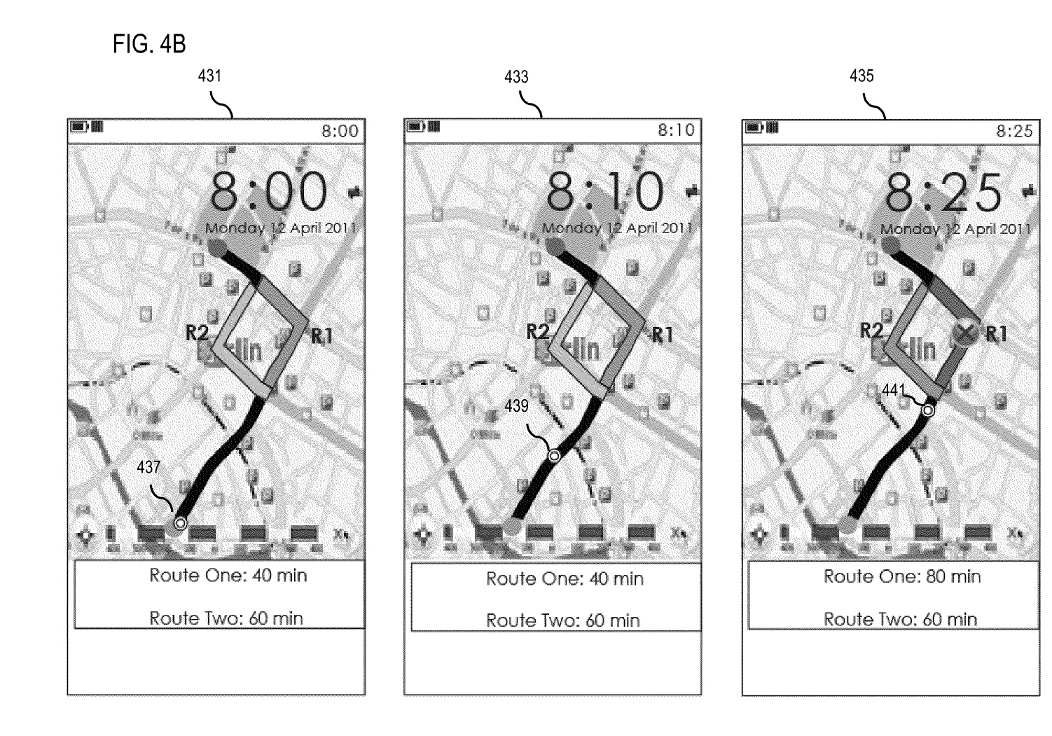

In another embodiment, the travel platform 103 processes and/or facilitates a processing of travel information to cause, at least in part, a generation of one or more recommendations based, at least in part, on travel conditions and average travel time. An example user interface (UI) of a UE 101 depicting such recommendations is depicted in FIGS. 4A and 4B. Similar to the previous examples, the travel platform 103 determines at least one prediction of a time that a UE 101, a user, or a combination thereof will travel to at least one of the one or more travel paths (e.g., Route One), the one or more places of interest (e.g., work), or a combination thereof. For example, by determining it is Monday at 8:00 a.m., the travel platform 103 is able to predict with high probability based on the user's travel graph, that the user will like drive to work.

In one example, the travel platform 103 determines based, at least in part, on the user's travel graph that the user's average driving time to work is 41 minutes. The travel platform 103 further predicts by processing and/or facilitating a processing of travel information (e.g., traffic information obtained from the service platform 111 or a service 115) that based, at least in part, on the traffic conditions at 6:55 a.m., the user is unlikely to experience delay during his or her commute to work. As a result, the travel platform 103 causes a presentation to the user of a green travel icon, which the user can use to determine that he or she can leave at the normal time to arrive at work on time. In another example, the travel platform 103 predicts by processing and/or facilitating a processing of travel information that based, at least in part, on the known traffic conditions at 6:55 a.m., the user's travel time to work will be between 40 and 55 minutes. As a result, the travel platform 103 causes a presentation to the user of a yellow travel icon, which the user can use to determine that he or should leave a little earlier than the normal to arrive at work on time. In a further example, the travel platform 103 predicts by processing and/or facilitating a processing of travel information that based, at least in part, on the traffic conditions at 6:55 a.m., the user's travel time to work will be between 55 and 65 minutes. As a result, the travel platform 103 causes a presentation to the user of a red travel icon, which the user can use to determine that he or she should leave significantly earlier than the normal to arrive at work on time. Alternatively, the user may want consider taking an alternative travel path given the fact that taking the normal travel path will result in considerable delay.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), traffic message channel (TMC) system, and the like, or any combination thereof.

The UEs 101 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, in-dash system, or any combination thereof, including the accessories and peripherals of these devices, or any combination thereof. It is also contemplated that the UEs 101 can support any type of interface to the user (such as “wearable” circuitry, etc.).

By way of example, the UEs 101, the travel platform 103, the service platform 111 and the content providers 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

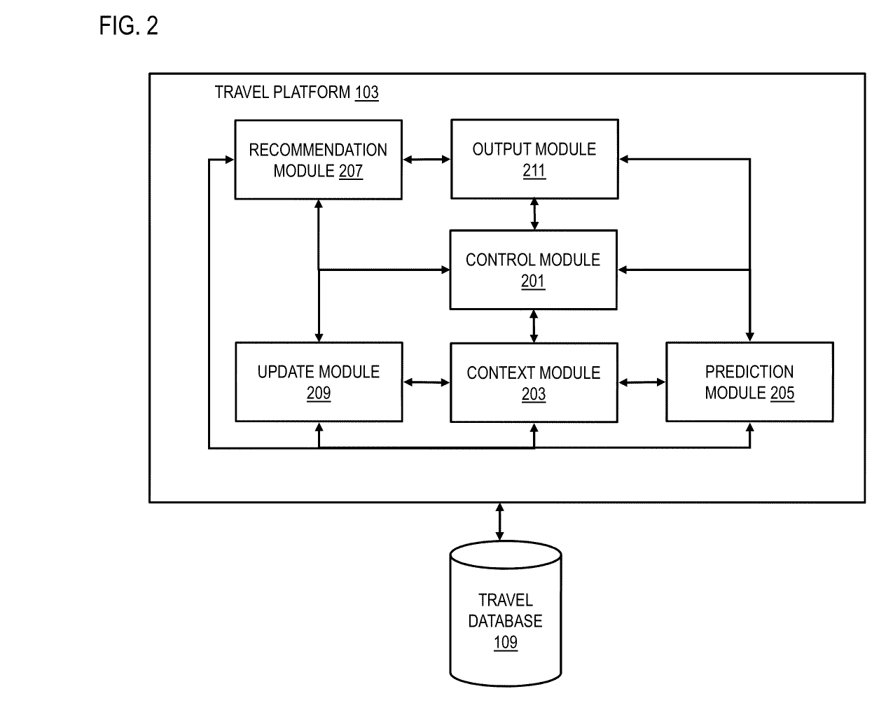

FIG. 2 is a diagram of the components of travel platform 103, according to one embodiment. By way of example, the travel platform 103 includes one or more components for providing driving assistant services to a user before, during, and after the user starts traveling. It is contemplated that the functions of these components may be combined in one or more components or performed by other components of equivalent functionality. In this embodiment, the travel platform 103 includes a control module 201, a context module 203, a prediction module 205, a recommendation module 207, an update module 209, and an output module 211.

The control module 201 oversees tasks, including tasks performed by the context module 203, the prediction module 205, the recommendation module 207, the update module 209, and the output module 211. For example, although the other modules may perform the actual task, the control module 201 may determine when and how those tasks are performed or otherwise direct the other modules to perform the task.

The context module 203 may determine the context or situation of a UE 101 by utilizing location-based technologies (GPS receivers, cellular triangulation, A-GPS, etc.) to determine location and temporal information regarding the UE 101. In particular, the context module 203 determines the personal travel pattern associated with the UEs 101, a user of the UEs 101, or a combination thereof to determine one or more of the user's travel paths, one or more places of interest, or a combination thereof. The context module 203 is also responsible for determining one or more travel associated travel times, associated contextual information, or a combination thereof. The context module 203 may also identify whether certain conditions or triggers have been met, such as whether a particular event has occurred (e.g., the movement or change of direction of the UEs 101), before instructing the prediction module 205 to determine a predicted time and/or location. The context module 203 may determine to store the personal travel pattern for future reference in the travel database 109.

The prediction module 205 may work with the context module 203 to first construct a travel graph and/or prediction model comprising a user's one or more travel paths, one or more places of interest, one or more travel associated travel times, associated contextual information, or a combination thereof, wherein at least one prediction (e.g., time, destination, etc.) is based, at least in part, on the user's travel graph. The prediction module 205 may also retrieve a personal travel pattern from the travel database 109. The prediction module 205 is also responsible for determining one or more relationships among the user's one or more travel paths, the one or more places of interest, or a combination thereof, wherein the user's travel graph is based, at least in part, on the one or more relationships. As previously discussed, a travel graph and/or prediction model can be a probabilistic model such as a Bayesian network or Markov network. Moreover, the prediction module 205 may make at least one prediction based, at least in part, on a score calculation for the user's one or more travel paths, the user's one or more places of interest, or a combination thereof, and wherein the score calculation is a likelihood score when using a probabilistic prediction module and a counting score when using a non-probabilistic prediction model. Furthermore, voice recognition can be aided using the probabilistic destination model. For example, a voice recognition system will first try to match what the user said based on the current context (e.g., names of likely destinations and alternatives).

In addition, the context module 203 may work with the recommendation module 207 to generate a recommendation to a user of at least one alternate travel path, at least one place of interest, or a combination thereof based, at least in part, on travel information obtained by the context module 203. The recommendation module 207 may also process information (e.g., the user's travel graph) that is determined by the prediction module 205. In particular, the context module 203 and the recommendation module 207 may work together in order to monitor location information associated with the UEs 101 while traveling to the one or more travel paths, the one or more places of interest, or a combination thereof. Moreover, when the context module 203 determines the UEs 101 are within a proximity of the one or more travel decision points (e.g., a fork in the road or an accident), the recommendation module 207 causes, at least in part, the generation, a presentation, or a combination thereof of the recommendation of at least one alternate travel path, at least one alternate place of interest, or a combination thereof. Furthermore, the recommendation module 207 may also cause, at least in part, a presentation of an amount of travel time saved by the user by taking the at least one alternate travel path, the at least one alternate place of interest, or a combination thereof. In addition, the recommendation module 207 may also cause a presentation to the user of a recommendation associated with the at least one of the user's one or more travel paths, the user's one of more places of interest, or a combination thereof prior to the time the user commences a travel, wherein the recommendation includes, at least in part, an eco-friendliness score, a safety score, a ranking score, or a combination thereof.

The update module 209 may work with the context module 203, the prediction module 205, and the recommendation module 207 to cause, at least in part, an update of the at least one prediction of time (e.g., 8:00 a.m. equals commute to work), the travel information (e.g., a car accident), the recommendation of at least one alternate travel path, at least one alternate place of interest, or a combination of thereof (e.g., take Route Two, an alternative supermarket is nearby), or a combination thereof for a predetermined period prior to, during, or after a user's commencement of travel.

In one embodiment, the output module 211 facilitates a creation and/or modification of at least one device user interface element, at least one device user interface functionality, or a combination thereof based, at least in part, on information, data, messages, and/or signals resulting from any of the processes and/or functions of the travel platform 103 and/or any of its components or modules. By way of example, a device interface element can be a display window, a prompt, an icon, and/or any other discrete part of the user interface presented at, for instance, the UE 101. In addition, a device's user interface functionality refers to any process, action, task, routine, etc. that supports or is triggered by one or more of the user interface elements. For example, user interface functionality may enable speech to text recognition, haptic feedback, and the like. Moreover, it is contemplated that the output module 211 can operate based at least in part on processes, steps, functions, actions, etc. taken locally (e.g., local respect to a UE 101) or remotely (e.g., over another component of the communication network 105 or other means of connectivity).

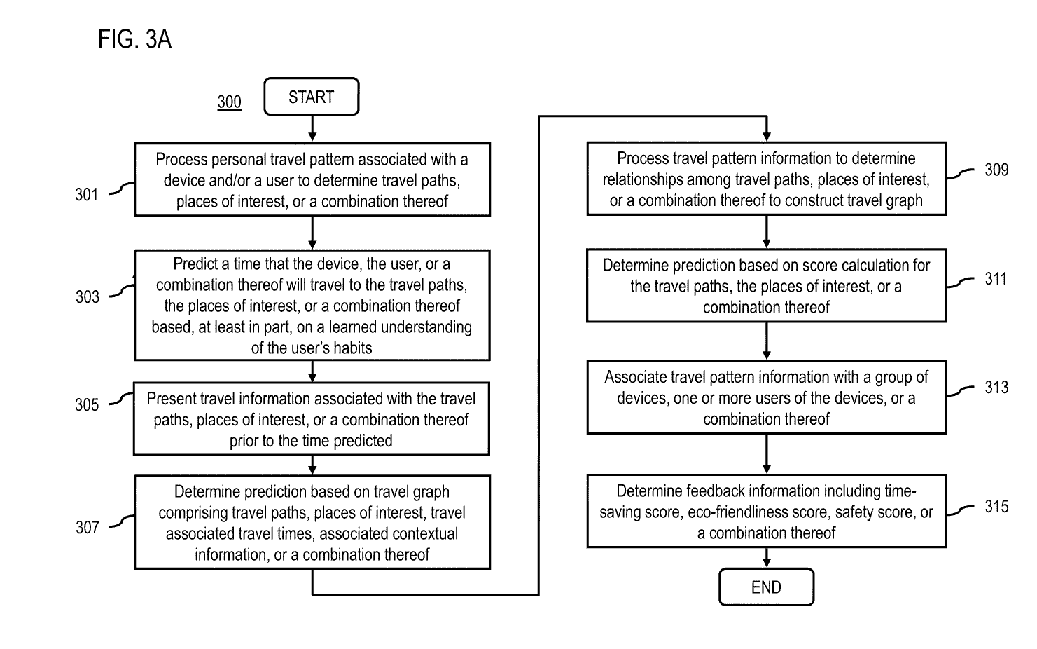

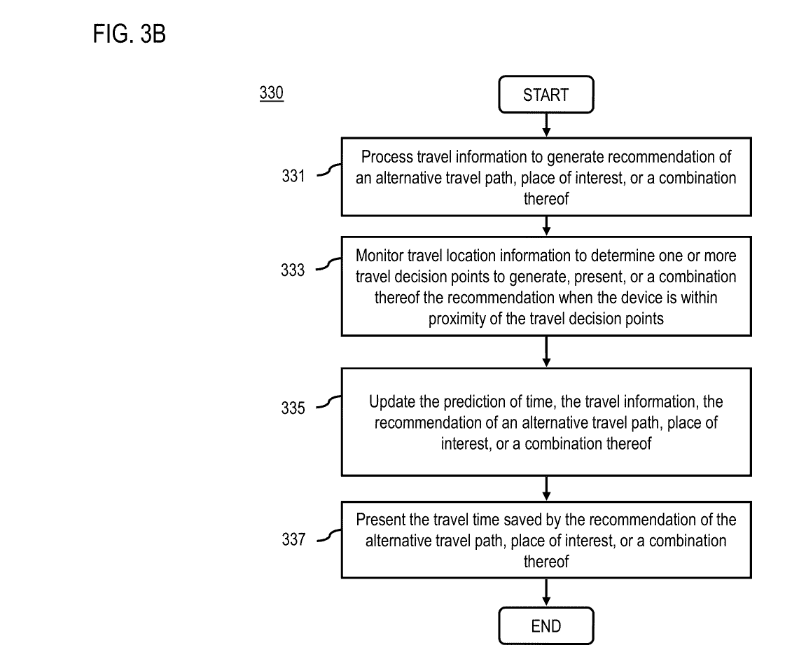

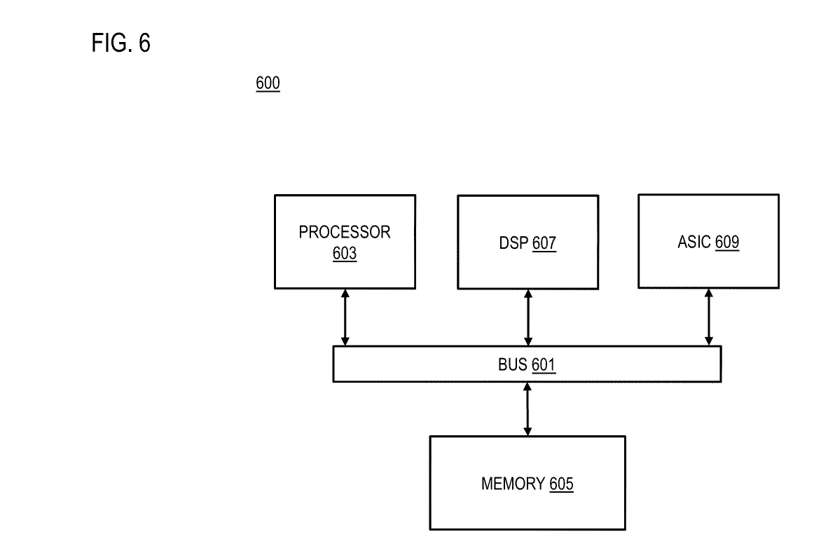

FIGS. 3A and 3B are flowcharts of processes for providing driving assistant services to a user before, during, and after the user starts traveling, according to one embodiment. FIG. 3A depicts a process 300 of making a traveling destination prediction before the user starts traveling. In one embodiment, the travel platform 103 performs the process 300 and is implemented in, for instance, a chip set including a processor and a memory as shown in FIG. 6. In step 301, the travel platform 103 processes and/or facilitates a processing of a personal travel pattern associated with a device, a user of the device, or a combination thereof to determine one or more travel paths, one or more places of interest of a combination thereof. As previously described, traveling predictions have been found to be more accurate when they are based on a user's historic travel data as opposed to predictions provided by various mapping/navigation services based on a large sampling of a population. Moreover, by determining the user's personal travel pattern, the travel platform 103 is able to make traveling predictions before the user starts driving.

In step 303, the travel platform 103 processes and/or facilitates a processing of the personal travel pattern to determine at least one prediction of a time that the device, the user, or a combination thereof will travel to at least one of the one or more travel paths, the one of more places of interest, or a combination thereof. The prediction of a time coincides with a prediction of a traveling destination. For example, if the travel platform 103 determines it is Monday morning at 7:00 a.m., the travel platform 103 can also predict that there is a high probability that the user will start his or her commute to work from his or her home at 8:00 a.m.

In step 305, the travel platform 103 causes, at least in part, a presentation of travel information associated with the at least one of the one or more travel paths, the one or more places of interest, or a combination thereof prior to the time. For example, the travel information can include the user's average travel time along a particular travel path. The travel information can also include real-time information provided by the service platform 111, services 115, and/or content providers 117 such as traffic, weather, construction, advertisements, etc. Moreover, because the travel platform 103 determines a personal travel pattern associated with the device, the user of the device, or a combination thereof, the travel platform 103 is able to present to the user the travel information prior to the time predicted. For example, if the travel platform 103 determines it is Monday morning at 7:00 a.m., the travel platform 103 can present to the user the travel information at 7:30 a.m., for example, in order to provide the user driving assistant services such as time to leave alerts and/or notifications. Specifically, if the travel platform 103 determines that there is no expected delay associated with the user's travel path to work the travel platform 103 may not alert the user. On the other hand, if the travel platform 103 determines that there is an expected 15-25 minute delay due to traffic conditions, the travel platform 103 can alert the user 30 minutes ahead of time that he or she should begin their commute early in order to arrive at work at the normal time.

In step 307, the travel platform 103 determines to construct a travel graph comprising the one or more travel paths, the one or more places of interest, one or more travel associated travel times, associated contextual information, or a combination thereof, wherein the at least one prediction is based, at least in part, on the travel graph. The travel graph and/or prediction model can be any model which considers the user's historical GPS data and/or driving data (e.g., temporal data, traveling speed data) to create and use the relationship among the user's one or more travel paths, the user's one or more places of interest, or a combination thereof (i.e., between starting places and ending places). As previously discussed, the travel graph can be a probabilistic model (e.g., a Bayesian network or a Markov network).

In step 309, the travel platform 103 processes and/or facilitates a processing of the personal travel pattern to determine one or more relationships among the one or more travel paths, the one or more places of interest, or a combination thereof, wherein the travel graph is based, at least in part, on the one or more relationships. For example, the travel graph may include any number of “important places” (e.g., work, home, a lunch restaurant, kindergarten, church, school, etc.) to the user. Specifically, the travel graph may comprise the times of day when the user traveled between the user's places of interest on a number of occasions. For example, without even knowing the identity of a particular location, the travel platform 103 can predict that if the user if leaving from a destination Monday through Friday at 8:00 a.m., there is a high probability that the destination is the user's home. Similarly, if the user is leaving from a destination Monday through Friday at 5:00 p.m., there is a high probability that the destination is the user's place of work.

In step 311, the travel platform 103 determines the at least one prediction is based, at least in part, on a score calculation for the one or more travel paths, the one or more places of interest, or a combination thereof, and wherein the score calculation is a likelihood score when using a probabilistic prediction model and a counting score when using a non-probabilistic prediction model. For example, if a probabilistic model is employed by the travel platform 103, destinations that the user is more likely to travel to on a regular basis (e.g., home, work, church) are given a greater and/or weighted score as opposed to destinations that the user is less likely to travel to on a regular basis (e.g., a fish market or florist shop). The greater the weight attributed to a particular destination the more likely the travel platform 103 will predict the user is traveling to that destination. One disadvantage of the prediction method is that the user's next travel destination cannot be perfectly predicted for any number of reasons (e.g., a bathroom break). As a result, the travel platform 103 suppresses unreliable predictions to get higher prediction accuracy.

In step 313, the travel platform 103 processes and/or facilitates a processing of a personal travel pattern associated with a group of one or more other devices, one or more other users of the one or more other devices, or a combination thereof. For example, the personal travel pattern associated with a user can be stored within the travel database 109 for future reference. As a result, if the user loses his or her mobile device or decides to upgrade to a new mobile device, the travel platform 103 is still able to make predictions about the user without having to re-determine the user's one or more travel paths, the user's one or more places of interest, or a combination thereof. Similarly, if the user has two mobile devices (e.g., a mobile phone and a mobile tablet), having the user's personal travel pattern stored in the travel database 109 provides the travel platform 103 access to the user's travel information irrespective of the particular mobile device the user is carrying on that particular day.

In step 315, the travel platform 103 determines feedback information associated with the at least one of the one or more travel paths, the one or more places of interest, or a combination thereof prior to the time, wherein the feedback information includes, at least in part, a time-saving score, an eco-friendliness score, a safety score, or a combination thereof. In one embodiment, the feedback information could also include a ranking score. This feedback information is intended to provide a user with information to make determinations about a particular travel path or a particular place of interest at a particular time. For example, the feedback information could demonstrate that if the user determines to travel to the supermarket at 5:30 p.m.—rush-hour—it is likely that the user will spend more time in traffic (i.e., create more CO₂ emissions) that had the user decided to travel to the supermarket during off-peak hours (e.g., between 7:00 p.m. and 9:00 p.m.).

FIG. 3B depicts a process 330 of making one or more traveling destination recommendations during or after a user commences traveling. In one embodiment, the travel platform 103 performs the process 330 and is implemented in, for instance, a chip set including a processor and a memory as shown in FIG. 6. In step 331, the travel platform 103 processes and/or facilitates a processing of travel information to cause, at least in part, a generation of a recommendation of at least one alternate travel path, at least one alternate place of interest, or a combination thereof. As previously discussed, the travel information could include the user's average travel time along a particular travel path. The travel information could also include real-time information provided by the service platform 111, services 115, and/or content providers 117 such as traffic, weather, construction, advertisements, etc. In this instance, the travel platform 103 recommends that one route (e.g., Route One) is typically a faster route to work (e.g., 40 minute average trip) compared with another route (e.g., Route Two) which is typically a slower route to work (e.g., 60 minute average trip) but on this occasion because of traffic blocking Route One, the travel platform 103 recommends to the user that he or she take the Route Two traveling path to work in order to save time and/or improve the quality of his or her commute.

In step 333, the travel platform 103 causes, at least in part, a monitoring of location information associated with the device while traveling to the one or more travel paths, the one or more places of interest, or combination thereof. The travel platform 103 also determines one or more travel decision points based, at least in part, on the location information. The travel platform 103 further causes, at least in part, the generation, a presentation, or a combination thereof of the recommendation when the location information indicates that the device is within a proximity of the one or more travel decision points. As previously mentioned, the travel platform 103 can utilize location-based technologies (GPS receivers, cellular triangulation, A-GPS, etc.) to determine location and temporal information regarding a UE 101. A travel decision point may be a fork in the road (e.g. where the user's travel path from his or her house separates into Route One or Route Two) or a traffic accident blocking a particular travel path to work (e.g., Route One). As previously discussed, the travel platform 103 may determine from location information that the user is approaching the fork in the road between Route One and Route Two and the travel platform 103 may simultaneously determine that from travel information provided by the service platform 111, one or more services 115 (e.g., news services, weather services, etc.), one or more content providers 117 (e.g., local news stations, local municipalities, etc.) that a large traffic accident is blocking Route One. Therefore, the travel platform 103 recommends that the user select Route Two as an alternative to the travel path typically selected by the user. Again, the travel platform 103 recommends that the user take the Route Two when the device is within a proximity of the travel decision point in order provide to the user with personalized driver assistant services and thereby enable the user to save time and/or improve the quality of his or her commute.

In step 335, the travel platform 103 causes, at least in part, an update of the at least one prediction, the travel information, the recommendation, or a combination thereof periodically, according to a schedule, on demand, a re-evaluation of a user's alternatives during the user's travel based, at least in part, on the most up-to-date real-time information available or a combination thereof for a predetermined period prior to, during, or after a commencement of travel. For example, the travel platform 103 can determine to provide a user with updated travel information every five minutes during the commute to work, but only every 20 minutes during the weekends when it may be less likely that the user will have to be at a particular destination at a particular time. In step 337, the travel platform 103 causes, at least in part, a presentation of an amount of travel time saved by the at least one alternate travel path, the at least one alternate place of interest, or a combination thereof. For example, the travel platform 103 can present to a user information regarding the fact that the user was able to avoid a traffic delay and thereby save 12 minutes on his or her commute to work. It is also contemplated that users may wish to share this information with their friends through social network services.

FIGS. 4A and 4B are diagrams of user interfaces utilized in the processes of FIGS. 3A and 3B, according to various embodiments. As shown, the example user interfaces of FIGS. 4A and 4B include one or more user interface elements and/or functionalities created and/or modified based, at least in part, on information, data, and/or signals resulting from the processes (e.g., processes 300 and 330) described with respect to FIGS. 3A and 3B. More specifically, FIG. 4A illustrates three user interfaces (e.g., interfaces 401, 403, and 405) with three different predictions before the user begins his or her travel to work. As shown in interfaces 401, 403, and 405, the user interfaces express the user's current time (e.g., 7:30 a.m.), the predicted destination (e.g., work), the user's average travel time to work (e.g., 40 minutes), the time at which the travel information (e.g., traffic) was determined (e.g., 6:55 a.m.), and the user's predicted travel time based, at least in part, on the determined travel information (e.g., no delay, no delay to a 15 minute delay, and a 15 to 25 minutes delay also indicated by the green, yellow, and red icons). As previously discussed, the travel platform 103's presentation to the user in user interface 401 of a green travel icon enables the user to determine that he or she can leave for work at the normal time and arrive at work on time. In another example, the travel platform 103's presentation to the user in interface 403 of a yellow travel icon enables the user to determine that he or should leave for work a little earlier than the normal to arrive at work on time. In a further example, the travel platform 103's presentation to the user in interface 405 of a red travel icon enables the user to determine that he or she should leave significantly earlier for work to arrive at work on time. Alternatively, in the red icon scenario the user may want to consider taking an alternative travel path.

FIG. 4B illustrates three user interfaces (e.g., interfaces 431, 433, and 435) at three different times (e.g., 8:00 a.m., 8:10 a.m., and 8:25 a.m.) and user's locations 437, 439, 441, respectively. As shown in interfaces 431, 433, and 435, the interfaces express a user's location associated with a UE 101 (e.g., obtained through a GPS receive and/or cellular triangulation) at the start of the user's commute to work, 10 minutes into the user's commute, and within close proximity to a travel decision point (e.g., a fork in the road separating Route One and Route Two). As shown in interface 431, the travel platform 103 predicts based on the user's personal travel pattern that at 8:00 a.m. there is a high probability that by selecting Route One it will take the user 40 minutes to reach work and by selecting Route Two it will take the user 60 minutes to reach work. If the user wants to make sure that he or she is at work by 9:00 a.m., it would be wise for the user to take Route One to work. As shown in interface 433, 10 minutes into the user's commute, the travel platform 103 may have processed and/or facilitated a processing of travel information (e.g., weather or scheduled road maintenance) to determine that Route One is still the recommended route in order to ensure that the user arrives at work before 9:00 a.m. As illustrated in interface 435, as the user arrives near a travel decision point (e.g., a fork in the road separating Route One and Route Two), the travel platform 103 determines from a local municipality service 115 that an accident is blocking Route One and therefore the travel platform 103 now recommends that by traveling on Route One it will take the user 80 minutes to arrive at work. In one embodiment, the user can select the 60 min Route Two by touching the touch screen on the Route Two. The Routes One or Two can be highlighted based on the one which presents the shorter time to the destination to give the user a better chance to select the fastest route between the two alternatives. The selection can be used to control the voice guidance to continue to guide the user through the selected route. As a result, the travel path along Route Two is now faster than the travel path along Route One. In this example, the travel platform 103 then recommends that the user take Route Two to arrive at work by 9:00 a.m.

The processes described herein for providing driving assistant services to a user before, during, and after the user starts traveling may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

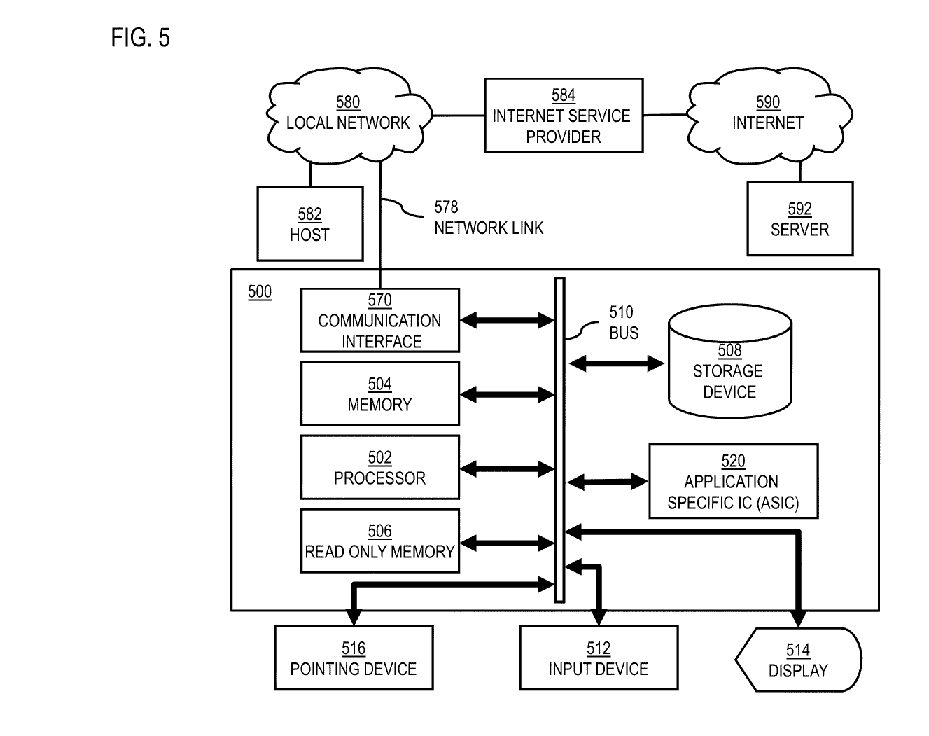

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to provide driving assistant services to a user before, during, and after the user starts traveling as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of providing driving assistant services to a user before, during, and after the user starts traveling.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to providing driving assistant services to a user before, during, and after the user starts traveling. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for providing driving assistant services to a user before, during, and after the user starts traveling. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for providing driving assistant services to a user before, during, and after the user starts traveling, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for providing driving assistant services to a user before, during, and after the user starts traveling to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to provide driving assistant services before, during, and after a user starts traveling as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of providing driving assistant services to a user before, during, and after the user starts traveling.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to provide driving assistant services before, during, and after a user starts traveling. The memory 605 also stores the data associated with or generated by the execution of the inventive steps.

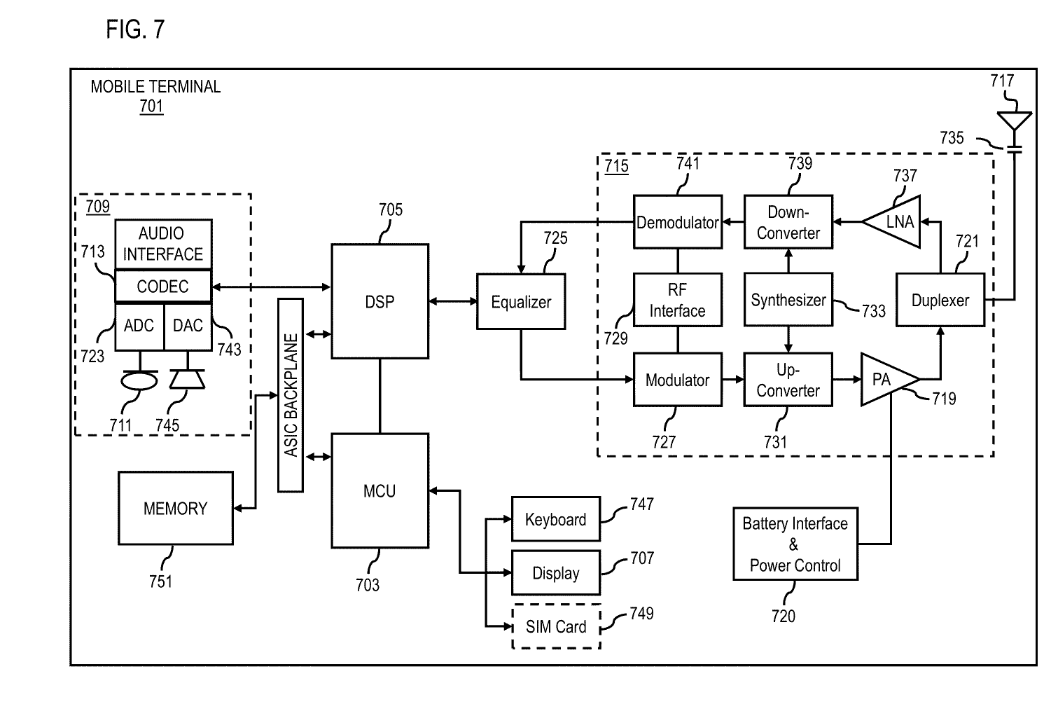

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of providing driving assistant services to a user before, during, and after the user starts traveling. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of providing driving assistant services to a user before, during, and after the user starts traveling. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to provide driving assistant services before, during, and after a user starts traveling. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of a personal travel pattern associated with a device, a user of the device, or a combination thereof to determine one or more travel paths, one or more places of interest, or a combination thereof;
a processing of the personal travel pattern to determine at least one prediction of a time that the device, the user, or a combination thereof will travel to at least one of the one or more travel paths, the one or more places of interest, or a combination thereof; and
a presentation of travel information associated with the at least one of the one or more travel paths, the one or more places of interest, or a combination thereof prior to the time.

2. A method of claim 1, wherein the (1) data and/or (2) information and/or (3) at least one signal are further based, at least in part, on the following:
at least one determination to construct a travel graph comprising the one or more travel paths, the one or more places of interest, one or more travel associated travel times, associated contextual information, or a combination thereof,
wherein the at least one prediction is based, at least in part, on the travel graph.

3. A method of claim 2, wherein the (1) data and/or (2) information and/or (3) at least one signal are further based, at least in part, on the following:
a processing of the personal travel pattern to determine one or more relationships among the one or more travel paths, the one or more places of interest, or a combination thereof,
wherein the travel graph is based, at least in part, on the one or more relationships.

4. A method of claim 1, wherein the (1) data and/or (2) information and/or (3) at least one signal are further based, at least in part, on the following:
a processing of travel information to cause, at least in part, a generation of a recommendation of at least one alternate travel path, at least one alternate place of interest, or a combination thereof.

5. A method of claim 4, wherein the (1) data and/or (2) information and/or (3) at least one signal are further based, at least in part, on the following:
a monitoring of location information associated with the device while traveling to the one or more travel paths, the one or more places of interest, or a combination thereof;
at least one determination of one or more travel decision points based, at least in part, on the location information; and
the generation, a presentation, or a combination thereof of the recommendation when the location information indicates that the device is within a proximity of the one or more travel decision points.

6. A method of claim 4, wherein the (1) data and/or (2) information and/or (3) at least one signal are further based, at least in part, on the following:
an update of the at least one prediction, the travel information, the recommendation, or a combination there periodically, according to a schedule, on demand, or a combination thereof for a predetermined period prior to, during, or after a commencement of travel.

7. A method of claim 6, wherein the at least one prediction is based, at least in part, on a score calculation for the one or more travel paths, the one or more places of interest, or a combination thereof, and wherein the score calculation is a likelihood score when using a probabilistic prediction model and a counting score when using a non-probabilistic prediction model.

8. A method of claim 4, wherein the (1) data and/or (2) information and/or (3) at least one signal are further based, at least in part, on the following:
a presentation of an amount of travel time saved by the at least one alternate travel path, the at least one alternate place of interest, or a combination thereof.

9. A method of claim 1, wherein the personal travel pattern is further associated with a group of one or more other devices, one or more other users of the one or more other devices, or a combination thereof.

10. A method of claim 1, wherein the (1) data and/or (2) information and/or (3) at least one signal are further based, at least in part, on the following:
at least one determination of feedback information associated with the at least one of the one or more travel paths, the one or more places of interest, or a combination thereof prior to the time,
wherein the feedback information includes, at least in part, a time-saving score, an eco-friendliness score, a safety score, or a combination thereof.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of a personal travel pattern associated with a device, a user of the device, or a combination thereof to determine one or more travel paths, one or more places of interest, or a combination thereof;
process and/or facilitate a processing of the personal travel pattern to determine at least one prediction of a time that the device, the user, or a combination thereof will travel to at least one of the one or more travel paths, the one or more places of interest, or a combination thereof; and
cause, at least in part, a presentation of travel information associated with the at least one of the one or more travel paths, the one or more places of interest, or a combination thereof prior to the time.

12. An apparatus of claim 11, wherein the apparatus is further caused to:
determine to construct a travel graph comprising the one or more travel paths, the one or more places of interest, one or more travel associated travel times, associated contextual information, or a combination thereof,
wherein the at least one prediction is based, at least in part, on the travel graph.

13. An apparatus of claim 12, wherein the apparatus is further caused to:
process and/or facilitate a processing of the personal travel pattern to determine one or more relationships among the one or more travel paths, the one or more places of interest, or a combination thereof,
wherein the travel graph is based, at least in part, on the one or more relationships.

14. An apparatus of claim 11, wherein the apparatus is further caused to:
process and/or facilitate a processing of travel information to cause, at least in part, a generation of a recommendation of at least one alternate travel path, at least one alternate place of interest, or a combination thereof.

15. An apparatus of claim 14, wherein the apparatus is further caused to:
cause, at least in part, a monitoring of location information associated with the device while traveling to the one or more travel paths, the one or more places of interest, or a combination thereof;
determine one or more travel decision points based, at least in part, on the location information; and
cause, at least in part, the generation, a presentation, or a combination thereof of the recommendation when the location information indicates that the device is within a proximity of the one or more travel decision points.

16. An apparatus of claim 14, wherein the apparatus is further caused to:
cause, at least in part, an update of the at least one prediction, the travel information, the recommendation, or a combination there periodically, according to a schedule, on demand, or a combination thereof for a predetermined period prior to, during, or after a commencement of travel.

17. An apparatus of claim 16, wherein the at least one prediction is based, at least in part, on a score calculation for the one or more travel paths, the one or more places of interest, or a combination thereof, and wherein the score calculation is a likelihood score when using a probabilistic prediction model and a counting score when using a non-probabilistic prediction model.

18. An apparatus of claim 14, wherein the apparatus is further caused to:
cause, at least in part, a presentation of an amount of travel time saved by the at least one alternate travel path, the at least one alternate place of interest, or a combination thereof.

19. An apparatus of claim 11, wherein the personal travel pattern is further associated with a group of one or more other devices, one or more other users of the one or more other devices, or a combination thereof.

20. An apparatus of claim 11, wherein the apparatus is further caused to:
determine feedback information associated with the at least one of the one or more travel paths, the one or more places of interest, or a combination thereof prior to the time,
wherein the feedback information includes, at least in part, a time-saving score, an eco-friendliness score, a safety score, or a combination thereof.

21-48. (canceled)
